(19) United States
(12) Patent Application Publication
(10) Pub. No.: US 2016/0008702 A1
(43) Pub. Date: Jan. 14, 2016

(54) BLACKJACK VARIATION WITH AUTOMATICALLY ELIMINATED CARD

(71) Applicant: Customized Games Limited, Shirley (GB)

(72) Inventor: Geoffrey William Hall, Shirley (GB)

(21) Appl. No.: 14/865,628

(22) Filed: Sep. 25, 2015

Related U.S. Application Data
(63) Continuation of application No. 13/539,113, filed on Jun. 29, 2012.
Application No. 13/539,113 is a continuation-in-part of application No. 13/219,697, filed on Aug. 28, 2011, now Pat. No. 8,398,084.
(60) Provisional application No. 61/448,189, filed on Mar. 1, 2011.
(60) Provisional application No. 61/448,193, filed on Mar. 1, 2011.
(60) Provisional application No. 61/448,642, filed on Mar. 2, 2011.

(51) Int. Cl. A63F 1/00; G07F 17/32; A63F 3/00

(52) U.S. Cl. CPC A63F 1/00; A63F 3/00157; G07F 17/322; G07F 17/3293; A63F 2001/003; A63F 2003/00164

(57) ABSTRACT

A method to implement a blackjack variation includes that, when the dealer is resolving the dealer's hand, if the dealer's point total is a preset total, then the dealer would automatically burn a card in the dealer's hand (such as the last card dealt to the dealer). The preset total can be twenty-one, so that, whenever the dealer's point total (after the dealer is done resolving the dealer's hand) is twenty-one, the dealer would burn a card in the dealer's hand. Thus, the dealer would typically have to draw another card, which could result in a better outcome for the player. (E.g., the dealer could bust or end up with a point total less than twenty-one).

### CROSS-REFERENCE TO RELATED APPLICATIONS

This application is a continuation of U.S. patent application Ser. No. 13/539,113, filed Jun. 29, 2012, which is a continuation-in-part of U.S. patent application Ser. No. 13/219,697, filed Aug. 28, 2011, now U.S. Pat. No. 8,398,084, issued Mar. 19, 2013, which claims the benefit of U.S. Provisional Patent Application Ser. No. 61/448,189, filed Mar. 1, 2011, U.S. Provisional Patent Application Ser. No. 61/448,193, filed Mar. 1, 2011, and U.S. Provisional Patent Application Ser. No. 61/448,642, filed Mar. 2, 2011, the disclosure of each of which is incorporated herein in its entirety by this reference.

### TECHNICAL FIELD

The present general inventive concept is directed to a method, an apparatus, and a computer-readable storage medium directed to a blackjack variation that can be played in a casino or on the Internet.

### BACKGROUND

The casino game of blackjack is well known. See, e.g., U.S. Patent Publication No. 2003/0155715, published Aug. 21, 2003, which is incorporated herein in its entirety by this reference.

FIG. 1 is a flowchart illustrating a method of implementing the known game of blackjack.

Points totals are computed by adding the standard rank value of each card, with face valued cards (tens, jacks, queens, kings) being given a value of ten, and aces being given a value of whichever of one and eleven results in a better hand. A “soft” point total is reached when at least one ace is given the value of eleven. A “hard” point total values all aces in a hand as worth one.

In operation 100, a player makes a main wager by placing chips on a table. Then, in operation 102, a dealer deals two initial cards to each player (either face up or face down) and two initial cards to the dealer, typically one face down (the “hole card”), and one face up (the “up card”). Then the player can decide, at operation 104, whether to hit, stand, double, or split. If the player decides to hit, then the method proceeds to operation 106, which deals an additional card to the player. If a determination 108 determines that the player has busted (the player's hard point total is over twenty-one), then the player loses the game and thus loses the main wager in operation 110, which ends the game. If the determination 108 determines that the player has not busted, then the method returns to operation 104, where the player can make another decision whether to hit or stand. In operation 104, the player can also double (not pictured) by placing an additional wager of up to the main wager, but the player is limited to drawing only one additional card before the player must stand.

If the player stands and has not busted (either stands on his or her initial two cards or draws cards but has a point total under twenty-two and then stands), then the method proceeds to operation 112, during which all dealer's cards are revealed (e.g., the hole card is turned face up) and during which the dealer's hand is then played out according to predetermined rules. During operation 114, if the dealer's total is greater than a predetermined amount (typically seventeen), then the dealer stands (proceeds to operation 122). If the dealer's total is not greater than the predetermined amount, the method proceeds to operation 116, during which an additional card is dealt to the dealer. If it is then determined, during operation 118, that the dealer has not busted (has a point total over twenty-one), the method returns to operation 114. If the dealer has busted, then the player, in operation 120, wins the game and the main wager. (This assumes the player has not also busted; if the player has already busted, then the player would have lost in operation 110.)

In operation 122, both the player and the dealer have played out his or her hand and neither has busted. Thus, their respective point totals (adding the numerical values of each card in the hand) are compared. If the dealer's point total is determined, in operation 124, to be lower than the player's point total, then the player wins the game and the main wager in operation 120. Otherwise, if the dealer's point total is determined, in operation 128, to be greater than the player's point total, then the player loses the game and the main wager in operation 130. If the player's point total ties the dealer's point total, then that results in a “push,” in operation 126, in which the player does not win or lose the main wager (the main wager bet is a wash).

If a player, in operation 102, is initially dealt two identically ranked cards, the player can also split, in operation 104, by placing an additional split wager equal in value to the main wager. The player's two initial cards are separated, and the dealer deals an additional card on each. The player then plays out each of the two separate hands, each from operation 104. Depending on house rules, players may or may not be allowed to resplit cards.

One disadvantage of the prior art game of blackjack is that players get upset when the dealer is initially dealt a good hand (such as a point total of twenty). What is needed is a new and entertaining version of blackjack that minimizes players' frustration by the dealer receiving good hands.

### BRIEF SUMMARY

It is an aspect of the present invention to provide an exciting casino game.

The above aspect can be obtained by a method that comprises (a) providing a physical gaming table and a physical deck(s) of cards; (b) receiving a wager from a player; (c) dealing a player's hand and a dealer's hand; (d) enabling the player to play out the player's hand; (e) providing dealer hand resolution rules that comprise: (A) if a point total of the dealer's hand is greater than a predetermined point total, then proceed to operation B, otherwise deal an additional card to the dealer's hand and return to operation A; and (B) if a point total of the dealer's hand is a preset total, then burning a card in the dealer's hand and return to operation A; (f) implementing the dealer hand resolution rules; and (g) resolving the wager according to the predetermined blackjack rules.

The above aspects can also be obtained by an apparatus that includes (a) a physical casino with a physical gaming table with a felt layout on top of the gaming table, which felt layout includes a plurality of betting circles imprinted into the felt layout; (b) one or more physical decks of cards; (c) physical chips; (d) a mechanical card shuffler; and (e) a set of rules comprising: (i) the player places a wager in the form of one or more physical chips in a player's betting circle out of the plurality of betting circles; (ii) the dealer deals, using the one or more physical decks of cards, a player's hand and a dealer's hand; (iii) the player plays out the player's hand; (iv) the dealer resolves the dealer's hand according to dealer hand resolution rules that comprise: (A) if a point total of the dealer's hand is greater than a predetermined point total, then proceed to operation B, otherwise dealing an additional card to the dealer's hand and return to operation A; and (B) if a point total of the dealer's hand is a preset total, then burning a card in the dealer's hand and return to operation A; and (v) the wager is resolved according to the predetermined blackjack rules. The set of rules would be printed on a rule card that is distributed at the table to players.

These aspects, together with other aspects and advantages that will be subsequently apparent, reside in the details of construction and operation, as more fully hereinafter described and claimed, reference being had to the accompanying drawings forming a part hereof, wherein like numerals refer to like parts throughout.

### BRIEF DESCRIPTION OF THE DRAWINGS

Further features and advantages of the present invention, as well as the structure and operation of various embodiments of the present invention, will become apparent and more readily appreciated from the following description of the preferred embodiments, taken in conjunction with the accompanying drawings of which:

FIG. 1 is a flowchart illustrating a method of implementing the known game of blackjack;

FIG. 2 is a flowchart illustrating an exemplary method of implementing a dealer burn procedure, according to an embodiment;

FIG. 3A is a drawing illustrating a gaming table, according to an embodiment;

FIG. 3B is a block diagram illustrating an electronic player tracking system associated with each gaming table, according to an embodiment;

FIG. 4A is a block diagram illustrating exemplary hardware that can be used to implement an electronic version of the methods described herein;

FIG. 4B is a block diagram illustrating an exemplary network configuration to implement a player playing an online version of the methods described herein;

FIG. 5 is a flowchart illustrating an exemplary method of burning a dealer's card when the dealer's final total is a preset total, according to an embodiment; and

FIG. 6 is a flowchart illustrating an exemplary method of burning a dealer's card when the dealer's final total is a preset total and the dealer's hand is formed using more than two cards, according to an embodiment.

### DETAILED DESCRIPTION

Reference will now be made in detail to the presently preferred embodiments of the invention, examples of which are illustrated in the accompanying drawings, wherein like reference numerals refer to like elements throughout.

The present inventive concept relates to a method, an apparatus, and a computer-readable storage medium to implement a blackjack side bet.

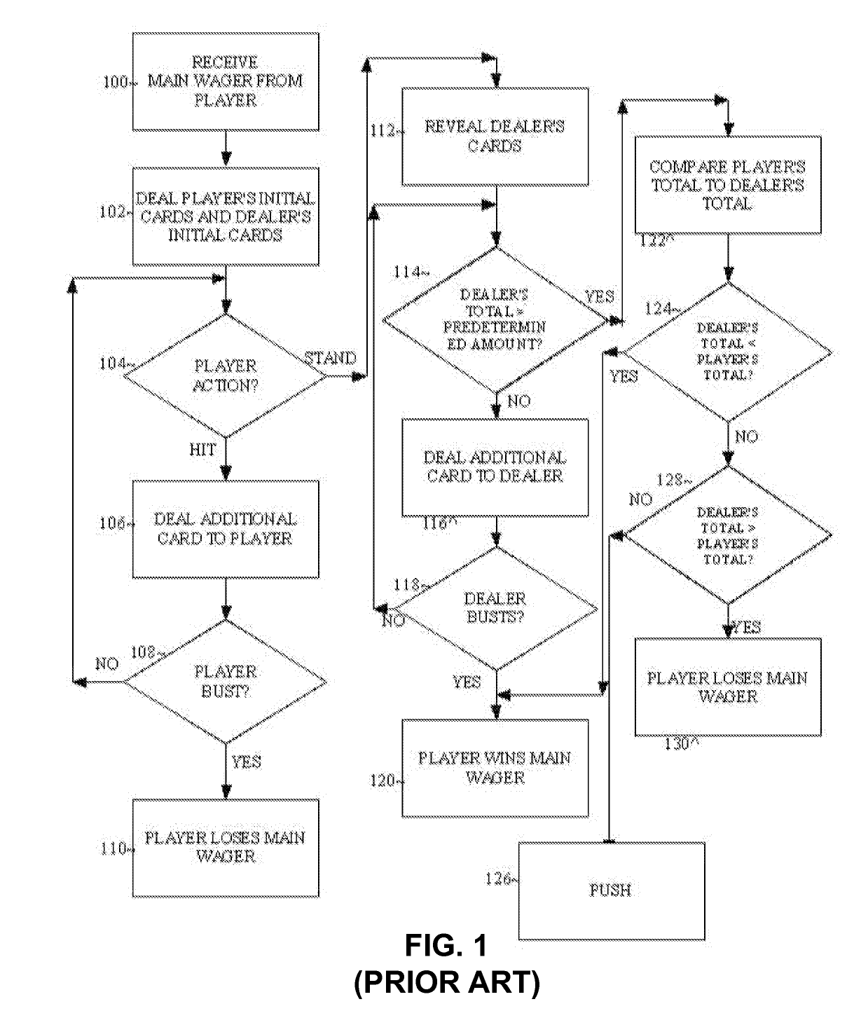

FIG. 1 is a flowchart illustrating a method of implementing the known game of blackjack.

In general, casino blackjack is played by one or more players at a gaming table against a dealer using one or more decks of cards (each deck can be a standard fifty-two card deck). The idea is for the player to make a point total closest to twenty-one without going over twenty-one (busting). Each player (after making a main wager) is dealt two initial cards (typically face up), and the dealer is also dealt two cards (one face up (the “up card”) and one face down (the “hole card”)). The player can stand on his or her initial two cards. Alternatively, the player can continuously hit (take another card) until the player stands or the player's point total is over twenty-one (upon which the player automatically loses). If the player has not busted, then, after the player stands, the dealer will play out the dealer's hand according to predetermined rules. One set of dealer predetermined rules is as follows: the dealer will continuously hit until the dealer's point total is greater than sixteen. Once the dealer has resolved the dealer's hand, the wager is resolved. If the player has busted, then the player loses (the main wager). If the player has not busted but the dealer has busted (the dealer's point total is over twenty-one), then the player wins (wins even money on the main wager). If both the player and the dealer have not busted and if the player's point total is higher than the dealer's point total, then the player wins (wins even money on the main wager). If both the player and the dealer have not busted and if the dealer's point total is higher than the player's point total, then the dealer wins (the player loses the main wager). If the player's point total equals the dealer's point total, then the main wager pushes (neither wins nor loses). Other options the player may have at his or her disposal is to double down or split. Cards are given their standard numerical value (i.e., aces count as one or eleven (whichever makes the best hand), twos through tens count as their respective face value while jacks, queens, and kings all count as ten).

The present inventive concept is a blackjack game that incorporates a “dealer burn procedure” in which a dealer will automatically burn the dealer's initial hand (initial two cards dealt) if the two cards are both ten-valued cards. The dealer will burn these two cards by removing the two dealer's cards, placing them into the discard rack, and then dealing the dealer two new cards (an up card and a hole card face down). Then, the game is continued. In this manner, the dealer would be unlikely to have a point total of twenty. (The only ways the dealer would have a point total of twenty is if the dealer has achieved the point total of twenty using more than two cards (e.g., seven, eight, five), if the dealer burns two ten-valued cards (both the dealer's up card and hole card are 10-valued cards) only to receive another two card point total of twenty, or if the dealer is dealt an ace and a nine.)

Players would typically find this version of blackjack attractive because players do not like when the dealer receives a point total of twenty (because this means the dealer has a very strong hand). Thus, the dealer would be unlikely to have a point total of twenty, and, thus, players would typically find the game less stressful when the player has a ten showing. In addition, this would change the player strategy and provide the player more opportunities to double down and split because the dealer would have a point total of twenty with much less frequency than the prior art version of blackjack.

In FIG. 1, operations 104 to 110 are those in which the player plays out the player's hand (e.g., hits, stands, doubles, splits, etc.) Operations 112 to 118 are those in which the dealer plays out the dealer's hand (e.g., continues to hit until the dealer's point total reaches a predetermined amount).

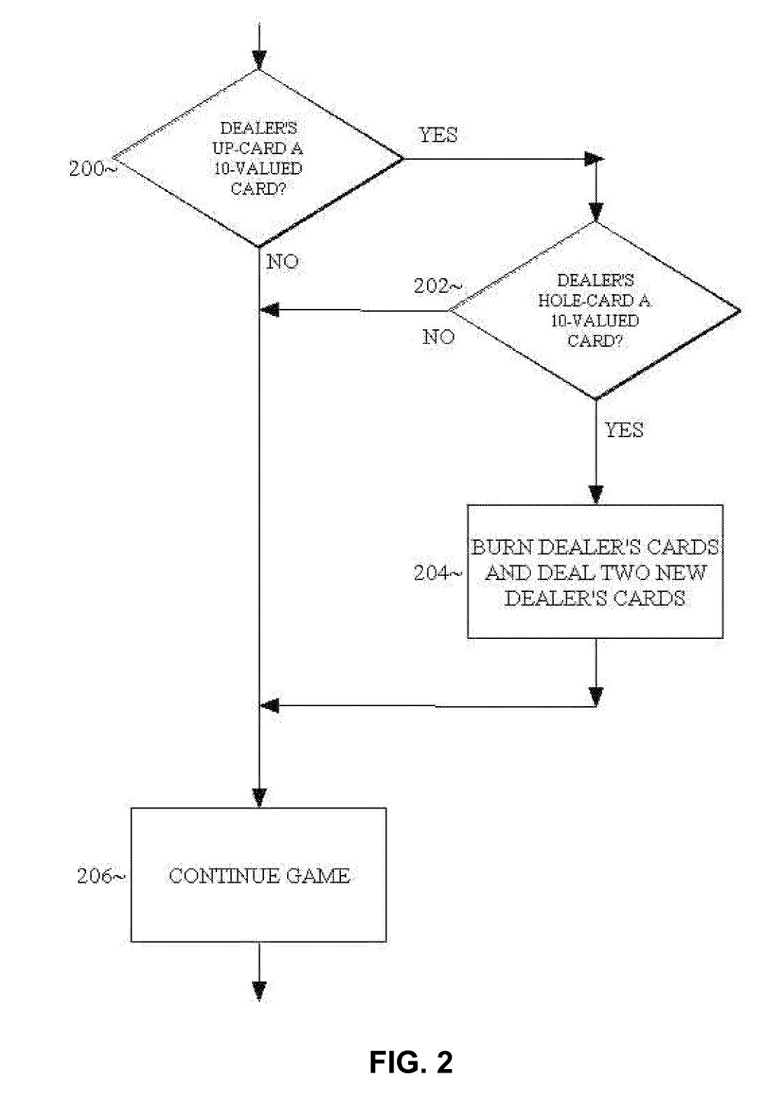

FIG. 2 is a flowchart illustrating an exemplary method of implementing a dealer burn procedure, according to an embodiment.

In a first embodiment, operations 200 to 206 can be performed between operations 102 to 104 of FIG. 1 (i.e., insert FIG. 2 between operations 102 and 104).

The dealer burn procedure would start with operation 200, in which it is determined whether the dealer's up card is a ten-valued card (ten, jack, queen, or king, with suits being irrelevant) and only a ten-valued card. Because up cards are dealt face up, this can be determined by visual inspection. If not, then the method proceeds to operation 206, which continues the game as if nothing has happened.

If, in operation 200, the dealer's up card is a ten-valued card, then the method proceeds to operation 202, in which it is determined whether the dealer's hole card is a ten-valued card (and only a ten-valued card). The dealer can peek at the dealer's hole card. This can be done in a number of ways. The dealer can physically peek at the hole card by crimping the card and looking under without revealing the card to the players. Alternatively, the dealer can use a mechanical (or electronic) hole card reader that can determine whether the hole card is a ten-valued card (or other programmed value) without the dealer knowing the value of the card (unless the hole card is a ten). Such a device is described in U.S. Pat. No. 5,681,039, issued Oct. 28, 1997, which is incorporated herein in its entirety by this reference. If the dealer's hole card is not a ten-valued card, then the method proceeds to operation 206, which continues the game as if nothing has happened.

If, in operation 202, it is determined that the dealer's hole card is a ten-valued card (meaning the dealer has a two-card point total of twenty), then the method proceeds to operation 204, in which the dealer's two cards (both the dealer's up card and the dealer's hole card) are burned and two new cards are dealt (also known as “redealing”) to the dealer, one face up (up card) and one face down (hole card). These two new cards are then used as a compete replacement to the original dealer's two cards. The term “burn” generally means to discard the cards and not use them further when completing the game. What actually happens to the burned cards (e.g., whether they are placed in the discard rack or elsewhere) is not important. The method then proceeds to operation 206. In an alternate embodiment, operation 204 would not burn and redeal both of the dealer's initial two cards (as described above), but only one (either the up card or the hole card) while keeping the other. Thus, for example, if the dealer had an up card of a ten and a hole card of a ten, the dealer would burn the hole card and redeal the hole card (e.g., a new card is dealt as the hole card face down but the original up card is kept), or, alternatively, a new card is dealt as the up card while the same hole card is kept. In this manner, the dealer keeps one ten-valued card but not both (although, of course, the redealt card could also be a ten-valued card).

From operations 200, 202, or 204 (depending on what happened during the procedure), the method continues to operation 206, which continues the blackjack game (e.g., the next operations in FIG. 1 can be performed, such as operation 104).

It is noted that the method described above with regard to FIG. 2 is performed between operations 102 and 104 (FIG. 1), so that, if the dealer had two ten-valued cards as the up card or the hole card, then the dealer's up card and hole card were both replaced with newly dealt random cards (a new up card and a new hole card). Note that, if the dealer has an ace and a nine as the two initial cards, this would be a point total of twenty but would not be subjected to the burn/replacement (operation 204). Thus, the player will face a dealer's point total of twenty much less frequently than it would be faced in standard blackjack.

In a second embodiment of the game, operations 200 to 206 of FIG. 2 would be performed between operations 112 to 114 of FIG. 1 (instead of between operations 102 to 104 as described in the first embodiment). In this embodiment, the player would also face a dealer point total of twenty less frequently than it would be faced in standard blackjack; however, the player would have already made his or her playing decisions. Thus, for example, if the player had busted (achieved a point total greater than twenty-one), then the player would still be out of the game regardless of whether the dealer burned the dealer's two cards or not. In this embodiment, it would not be necessary for the dealer to have to peek at the hole card (without the players seeing it) because the dealer's cards have already been revealed (in operation 112 (FIG. 1)).

It is noted that FIG. 2 illustrates the concept of burn conditions. If the dealer's cards meet the burn conditions, then the dealer would burn the dealer's cards in operation 204. If the dealer's cards do not meet the burn conditions, then the dealer would not burn the dealer's cards. The burn conditions can remain constant throughout the game, or they can change (e.g., after a first burn then the burn condition changes). Of course, after each game is over and a new game is dealt, the burn conditions are reset. (In other words, if a burn is performed in one game, it has no effect on a subsequent game.)

The second embodiment could be applied to the “European hole card rule,” wherein the dealer is not dealt a hole card but only an up card in operation 102 (FIG. 1). After all of the players at the table have played out their respective hands, then the dealer, in operation 112, deals himself/herself a second card face up. (This would serve as the hole card, but there is no need now to deal it face down because all players have made their decisions.) After the dealer's second card is dealt, then operations 200 to 206 (FIG. 2) are performed, and then the game can continue with operation 114 (FIG. 1).

In a further embodiment, from operation 204 (FIG. 2), the method would return to operation 200 (instead of proceeding to operation 206). In this manner, if the dealer burned two ten-valued cards (cards with a value of ten, e.g., any ten, jack, queen, or king) and the dealer again received two ten-valued cards, the dealer would burn the second two ten-valued cards (and all future two ten-valued cards) until the dealer is dealt two initial cards (up card, hole card) that are not two ten-valued cards (or does not meet the burn condition). In this embodiment, it would be impossible for the dealer to have an initial point total of twenty using two cards (unless the two cards are an ace and a nine), although, of course, the dealer would still be able to achieve a point total of twenty using three or more cards. In a further variation of this embodiment, the dealer may burn a predetermined number of two ten-valued cards (e.g., two or three) before keeping the next two ten-valued cards. For example, a predetermined house rule may provide that the dealer will burn two ten-valued cards twice at most (two different sets of initially dealt ten-valued cards). For example, if the dealer were dealt a first two ten-valued cards, burned those, and dealt himself/herself another two ten-valued cards, the dealer would burn the second two ten-valued cards as well. Then, if the dealer dealt himself/herself a third two ten-valued cards, the dealer would not burn the third two ten-valued cards, but would have to keep it (because the dealer reached the limit). This cap on burning hands avoids a potential “infinite loop” of continuing to burn cards from the shoe/deck.

It is noted that, when implementing a subsequent burn procedure (as described above), wherein, after an initial burn, another burn procedure is implemented (going from operation 204 back to operation 200), the criterion for burning would remain the same. However, in an alternative embodiment, the criterion for burning, in a subsequent burn, can be different than the initial burn. For example, the criteria for an initial burn can be that the dealer's two initial cards are two ten-valued cards, and the criteria for a subsequent burn can be that the dealer's two new cards (the two new cards dealt to the dealer after the burn (not dealer's draw cards)) form a blackjack (one card is a ten-valued card and the other card is an ace or vice-versa). Thus, for example, consider a game in which the initial burn condition is that both dealer's initial cards are each ten-valued cards, and the subsequent burn condition is that both dealer's new cards are both ten-valued cards or form a blackjack. Thus, if the dealer is initially dealt an ace as the up card and a ten as the hole card, this would not be burned and play would continue normally. However, if the dealer is initially dealt a king and a jack (two ten-valued cards). then these would be burned. If the dealer is now dealt an ace up card and a ten hole card, these would be burned also, and another new pair of dealer cards (up card, hole card) would be dealt to the dealer. Typically, all subsequent burn procedures (not including the initial burn procedure) would have the same burn conditions, although it is not required.

In another embodiment, the game can have a dealer burn condition by which the dealer's cards are burned when either (a) both of the dealer's cards are ten-valued cards or (b) the dealer's up card is a ten-valued card and the dealer's hole card is a suited ace (which matches the suit of the ten-valued up card). In either circumstance, these cards will be burned also. If the hole card is not a suited ace (or a ten-valued card), then there would be no burn.

In yet a further embodiment, operation 200 would determine whether the dealer's up card is either a ten-valued card or an ace (instead of just a ten-valued card). In this embodiment, if the dealer has an ace-up blackjack (the dealer's hole card is a ten-valued card) this would trigger a burn and deal (operation 204), thus reducing the frequency the dealer receives a blackjack.

In yet a further embodiment, operation 200 would determine whether the dealer's up card is either a ten-valued card or an ace (instead of just a ten-valued card), and operation 202 would (A), if the dealer's up card is an ace, determine whether the hole card is a ten-valued card, and (B), if the dealer's up card is a ten-valued card, determine whether the hole card is either a ten-valued card or an ace. Another way of phrasing operations 200 to 202 would be that, in the operations, it is determined whether the dealer's initial two cards are either a blackjack or comprise two ten-cards. Only if one of these conditions is met (the dealer's initial two cards are either a blackjack or are two ten-valued cards) then operation 204 is performed. In this embodiment, it would not be possible for the dealer to be dealt a blackjack or two ten-valued cards without triggering a burn and deal (operation 204).

In a less preferred embodiment, operation 200 could check the dealer's hole card, and operation 202 could check the dealer's up card.

The methods described herein provide the player with an advantage over standard blackjack in that the number of times the dealer receives an initial hand of twenty is reduced. Therefore, if a player were to play optimal strategy for this game, the player would have an advantage over the house. Thus, for the casino to profit from this game, an equalizing element must be added to the game so that the house advantage is maintained. One way this can be done is by implementing the game with a “push on 22” feature. This feature is described in U.S. Pat. No. 7,435,172, issued Oct. 14, 2008, which is incorporated herein in its entirety by this reference. In this embodiment, when the player has not busted and the dealer busts (“yes” from operation 118) with a dealer's point total of twenty-two (but not twenty-three or higher), the player's wager (made in operation 100) would push (instead of winning as in operation 120). Other dealer point totals besides twenty-two (e.g., twenty-three, twenty-four, twenty-five, or twenty-six) can be used to push the player's wager. This feature gives the house an additional advantage (because players would win more by winning instead of pushing). Alternatively, instead of using the “push on 22” feature as the equalizing element, other equalizing elements can be used as well. Some other known equalizing elements are paying even money on blackjacks, using a Spanish deck (a standard deck with all tens removed), etc.

Table I below illustrates one sample set of rules. Of course, any combination of rule changes can be used.

TABLE I

| 1. | The game is played using six standard fifty-two-card decks. | |
|---|---|---|
| 2. | To begin, the player makes a wager. | |
| 3. | The dealer deals two cards face up to the player. He deals to himself, | |
| | one card face up and one card face down. | |
| 4. | If the dealer's up card is any ten, the dealer will peek at his hole | |
| | card and burn both cards if he has either a suited blackjack or twenty | |
| | points. The dealer will then deal two new cards to himself, one face | |
| | up and one face down. After a first burn, with an ace or a ten up card, | |
| | the dealer will peek at his hole card and burn both cards if he has | |
| | either a blackjack (suited or off suit) or any two tens. This process | |
| | will continue until the dealer's hand does not consist of a blackjack | |
| | or any two tens. | |
| | 5. | The game then proceeds using the following blackjack rules: |
| | a) | Blackjacks pay three to two (3:2). |
| | b) | Players may double down on any two cards, including after |
| | | splitting. |
| | c) | Players may re-split pairs any number of times, excluding aces. |
| | d) | Aces may be split once and receive one card only. |
| | e) | The dealer stands on soft seventeens. |
| | f) | A dealer total of twenty-two points is considered a push against |
| | | any player total of twenty-one or less. A player blackjack will |
| | | still beat a dealer twenty-two. |
| | g) | If the dealer's up card is an ace, players may take insurance for |
| | | up to half of their wager. Insurance pays two to one (2:1) if the |
| | | dealer has a blackjack. |

Any combination/set of rule variation can be used. Possible rule variations include (but are not limited to) the number of decks used (one, two, four, six, eight, or a continuous shuffling machine); blackjack pays six to five (6:5) vs. three to two (3:2) vs. one to one (1:1); dealer hits soft seventeens (vs. stands on soft seventeens); the player is allowed to double on any number of cards (vs. being allowed to double on only the first two cards); the player is allowed to re-split aces (vs. not being allowed to re-split aces); the player is allowed to re-split pairs any number of times (vs. only being allowed to split pairs one, twice, three times, or another number of times); the player is allowed to surrender (except when the dealer has a blackjack) the player's first two cards in exchange for receiving 50% of the player's bet back (vs. not being allowed to surrender); a dealer bust on twenty-two could push the player's live bets (instead of pay them) vs. any other mechanism to give the house an advantage.

It is noted that, if the criteria for burning is that the two dealer's cards are each ten-valued cards, then an ace and a nine would not be burned (because this is not two ten-valued cards, even though it totals twenty). However, in an alternative embodiment, a condition for burning can be the first two dealer's cards totaling twenty (regardless of their composition), and, in this embodiment, all twenties would be burned (even using an ace and a nine).

Table II below is an example of a set of burn conditions (both initial, for the first two dealer's cards, and subsequent, for after the dealer's first burn) that can be used. Of course, numerous such conditions can be devised and implemented. In some embodiments, there would be no subsequent burn conditions because all subsequent burn conditions would be the same as the initial burn conditions. In one embodiment, the dealer's cards can be burned a maximum of one time. In another embodiment, the dealer's card can be burned a maximum of a predetermined number of times (e.g., three times). In another embodiment, there is no limit to the number of times the dealer's cards can be burned (of course, as long as the dealer's cards keep meeting the required burn conditions).

TABLE II
Initial burn condition:

| | |
|---|---|
| a) | if both dealer's cards are ten-valued cards; or |
| b) | if the dealer's up card is a ten-valued card and the dealer's hole |

card is a suited ace.

Subsequent burn condition:

| | |
|---|---|
| a) | if both the dealer's cards are ten-valued cards; or |
| b) | if both the dealer's cards form any blackjack. |

Table III below illustrates a set of complete rules for one embodiment of the game. Of course, any rule variation/combination can be used. In addition, initial and subsequent burn conditions (what triggers a burn) can be identical or different and can comprise any of the conditions described herein (or any others not described herein). If the dealer's cards do not meet the burn conditions, then the dealer does not perform a burn, and play continues using blackjack rules. Note that, even though a dealer total of twenty-two pushes all live bets on the table (where the dealer did not bust), player blackjacks still win. While the below rules state that aces can be split only once, in other embodiments aces can be split more than once (and up to four times in an embodiment). In another embodiment, dealers can also stand on soft seventeen. Note also that, if the dealer does not have a predetermined up card that triggers a dealer peek at the dealer's hole card, then the dealer would not peek at the dealer's hole card (because the dealer would have no reason to peek because a burn would be impossible). “Suited ace” in Table III refers to the same suit as the ten-valued up card.

TABLE III
On the initial deal: with a ten-valued up card, dealer peeks and burns only
another ten or a suited ace
After a first burn: with a ten-valued up card, dealer peeks and burns only
another ten or any ace
After a first burn: with an ace up card, dealer peeks and burns only any ten
Players are allowed to double on any number of cards
One card to resplit aces
Aces split only once
Blackjacks pay three to two (3:2)
Players are allowed to double after splitting
Players are allowed to take Insurance against a dealer ace
Dealer will hit soft seventeen
Dealer will push all bets on a total of twenty-two (except player blackjacks
will still win)

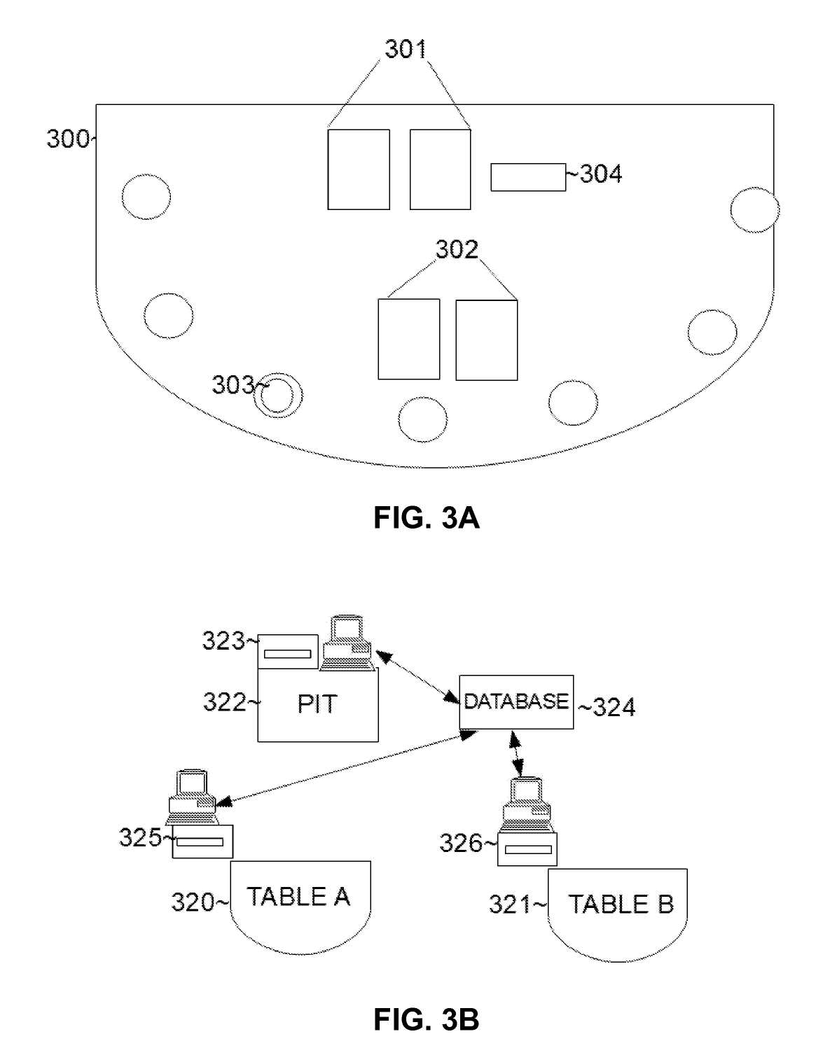

FIG. 3A is a drawing illustrating a gaming table, according to an embodiment.

A physical gaming table 300 (typically made of wood with felt on top with the layout imprinted on it) is used to play the game in a physical, real-world casino. One example of a table that can be used in a physical casino is illustrated in U.S. Design Pat. No. D263,975, issued Apr. 20, 1982, which is incorporated herein in its entirety by this reference. The layout on top of the felt has imprinted on it seven betting circles as illustrated in FIG. 3A. Each betting circle is where the respective player can place his or her chips (wager). The felt can be green, and the imprinted betting circles can be white, although, of course, any color scheme can be used. Such a table 300 can accommodate any number of players (such as seven, as illustrated, or any other number (e.g. two to ten players)). All players play simultaneously against the dealer, as known in the art. A player's hand 302 and a dealer's hand 301 are shown. A player's wager 303 is shown in the form of a chip or chips and is placed inside the player's betting circle. The dealer's area can also accommodate a physical card reader for reading the dealer's hole card as described in U.S. Pat. No. 5,681,039, issued Oct. 28, 1997, which is incorporated herein in its entirety, for all purposes, by this reference. The physical card reader can be an electronic card reader that electronically scans a face down card and lights up a particular light (e.g., LED, etc.) if the face down card is a ten or an ace (which would give the dealer a blackjack when the dealer's up card is an ace or a ten, respectively). Otherwise, a different light (e.g., a “green light”) lights up, telling the dealer that the hole card does not give the dealer a blackjack and, thus, the dealer can continue dealing.

While not shown, the game can also be offered with any type of additional side bet to generate more action for the casino and more excitement for the players. Also not pictured in FIG. 3A is an electronic mechanical shuffler, such as that described in U.S. Pat. No. 8,025,294. issued Sep. 27, 2011, which is incorporated herein in its entirety by this reference, which electronic mechanical shuffler can optionally be used by the dealer to shuffle the deck or decks of cards. Also not pictured in FIG. 3A is an optional shoe into which the cards can be placed and out of which the cards can be dealt by the dealer, such as the shoe described in U.S. Pat. No. 4,457,512, issued Jul. 3, 1984, which is incorporated herein in its entirety by this reference.

FIG. 3B is a block diagram illustrating an electronic player tracking system associated with each gaming table, according to an embodiment.

When players play casino table games, the casino can typically track the player so that the casino knows how much gaming action a player is giving the casino and, hence, how much to reward each player with complimentaries (free or discounted rooms, food, etc.). Such a system is described in U.S. Pat. No. 5,836,817, issued Nov. 17, 1998, which is incorporated herein in its entirety, for all purposes, by this reference. Each player can have his or her own player's card, which is a plastic card that has the player's name imprinted on it and computer-readable indicia (e.g., a magnetic strip) that stores an identification number of the player's card (and hence the identification number of the player who owns the card). The player's card can be swiped through an electronic card reader 323, 325, 326, which can be electronically read and the data therein transmitted to an associated computer.

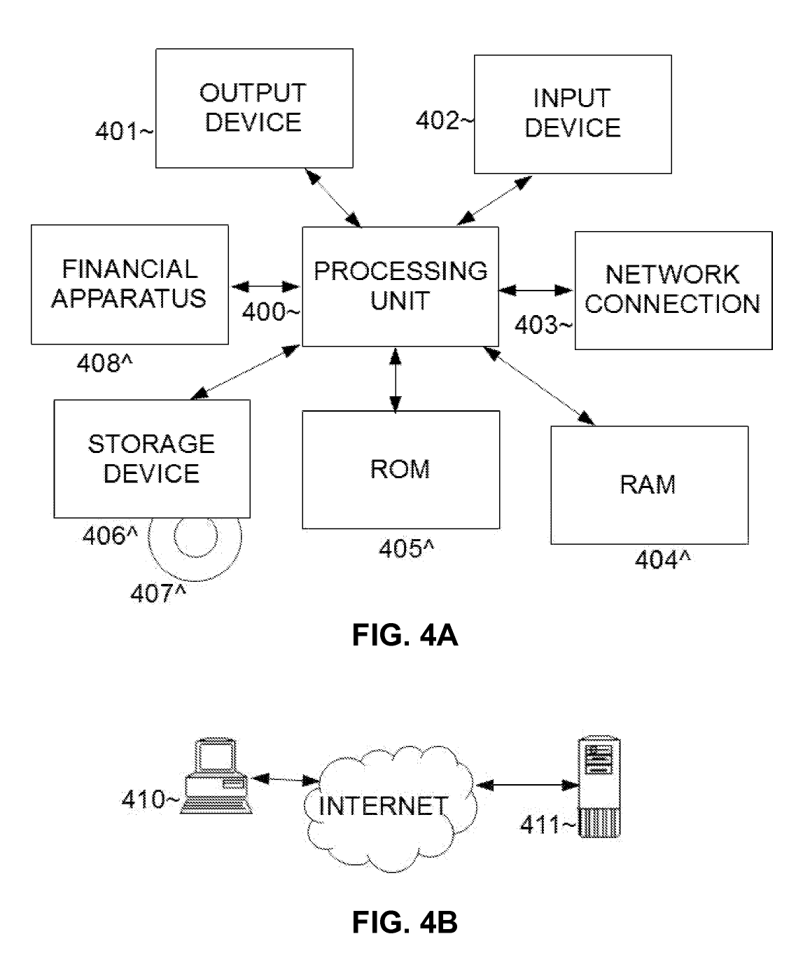

A gaming table A 320 (which can be used to play any method described herein) and a gaming table B 321 (which can be used to play any method described herein) can be associated with a pit 322 (which has its own computer), which has a card reader 323 to read the electronically encoded information on a player's card (the card reader can also be located at the tables 320, 321 themselves) and to transmit the information to an associated computer, which can communicate information contained on the player's card (e.g., an identification number of the player associated with the card) to an electronic database 324 along with play data relating to the player who owns the player's card. Table A 320 has its own card reader 325 and associated computer (the one next to card reader 325, which computer receives information from the card reader 325), and table B 321 also has its own card reader 326 and associated computer (the one next to card reader 326, which computer receives information from the card reader 326). The computers at table A 320 and table B 321, respectively, are connected to the electronic database 324. Casino employees can enter data regarding each player's play (for those players that present a player's card) into a computer at the table 320, 321 or at the pit 322, which computer transmits the play data (e.g., average bet amount, time of play, etc.) to the electronic casino database 324 that stores playing history information for players at the casino. The computers illustrated in FIG. 3B can all have the structure as illustrated in FIG. 4A.

FIG. 4A is a block diagram illustrating hardware that can be used to implement electronic versions of the wagering methods described herein, according to an embodiment. The hardware can be, for example, an electronic gaming machine (EGM) used in casinos. The hardware can also be a personal computer, playing the game using the Internet at an Internet casino for real money. The hardware can also be a digital casino table, for example, the kind described in U.S. Pat. No. 7,775,887, issued Aug. 17, 2010, which is incorporated herein in its entirety by this reference. The hardware can also be any computing device, such as a cellular phone, a tablet, etc., and the methods described herein can be installed as software (e.g., an app) on the device. The hardware can also be any other type of device, working individually or in conjunction with other devices.

A processing unit 400 (such as a microprocessor and any associated components) is connected to an output device 401 (such as an LCD monitor, a touch screen, a CRT, etc.) and an input device 402 (e.g., buttons, a touch screen, a keyboard, a mouse, etc.). All methods described herein can be performed by the processing unit 400 by loading and executing respective instructions. The processing unit 400 can also be connected to a network connection 403, which can connect the electronic gaming device to a computer communications network, such as the Internet, a LAN, a WAN, etc. The processing unit 400 is also connected to RAM 404 and ROM 405. The processing unit 400 is also connected to a storage device 406, which can be a DVD-drive, CD-ROM, flash memory, etc. Multiple such processing units 400 can also work in collaboration with each other (in a same or different physical location). A computer readable storage medium 407 can store a program that can control the electronic device to perform any of the methods described herein. The processing unit 400 can also be connected to a financial apparatus 408 that can receive cash and convert the received cash into playable credits for use by the player when playing the electronic device. When the player decides to cash out any remaining credits, the financial apparatus 408 can issue coins or a cashless ticket (voucher) for the remaining credits, which cashless ticket (voucher) is redeemable by the player.

FIG. 4B is a block diagram illustrating an exemplary network configuration to implement a player playing an online version of the methods described herein. All the methods described herein can be implemented on an online casino for real money (or non-cash value credits). A player uses a computer 410 (e.g., cell phone, tablet, PC, etc.) that can connect to a server 411 using a computer communications network, such as the Internet. The server 411 hosts an online casino that determines the outcomes of the game and serves the outcomes to the computer 410 so the computer 410 displays the outcomes to the player. The configuration of online casinos is well known in the art.

An example of the game will now be presented to help illustrate the game. Bob bets (operation 100) $1 and is dealt (operation 102) a five-diamonds/ace-spades (5♦/A [symbol] ) (note that, typically, in standard blackjack, the suits are not relevant). The dealer is dealt (operation 102) an up card of nine-hearts (9♡) and a face down hole card. Because the up card is not a ten-valued card, the game continues normally. Bob hits (operation 106) and receives a three-hearts (3♡). The dealer turns over the hole card (operation 112), which is a nine-spades (9 [symbol] ). Because Bob's point total of nineteen beats the dealer's point total of eighteen, Bob wins (operation 120). Bob is paid $1, and Bob's original $1 wager remains. (Thus, Bob can remove $2 from the table for a net profit of $1.)

As another example, Sara bets (operation 100) $1 and is dealt (operation 102) a two-clubs/eight-diamonds (2 [symbol] /8♦), and the dealer is dealt (operation 102) an up card of ten-hearts (10♡) and a face down hole card. Because it is determined (operation 200) that the up card is a ten-valued card, the dealer peeks (operation 202) at the hole card (operation 202) and determines (operation 202) that the hole card is a ten-clubs (10 [symbol] ). Because the dealer has an initial hand of two ten-valued cards, the dealer turns over (operation 204, part of the burn) the hole card to reveal to all of the players the dealer's hand. Then the dealer burns (operation 204) the two ten-valued card hand of twenty (typically by placing these two cards in the discard rack), and the dealer now deals (operation 204) the dealer a new up card (of five-diamonds (5♦)) and a new hole card. Sara now decides to double (operation 104, doubling not pictured), placing another $1 wager, and is dealt a five-clubs (5 [symbol] ). The dealer now reveals (operation 112) the hole card to be a ten-spades (10 [symbol] ), and the dealer hits and receives a five-spades (5 [symbol] ). Because the dealer's total of twenty is higher than Sara's total of fifteen, Sara loses (operation 130) both $1 wagers (for a total of $2), and these $2 in wagers are taken by the dealer and kept by the house.

It is further noted that other card values for the determinations in operations 200 and 202 can be used (other than those described above). For example, card values can be checked for different values (individual values or a set of different values) in combination with suits, colors, etc.

In a further embodiment, if the dealer's final total is a preset total, then the dealer would automatically burn a card and continue resolving the dealer's hand. For example, if the dealer's total is a twenty-one (a preset total) then the dealer would burn (remove a card and continue dealing). Thus, a dealer's twenty-one (which is bad for the players) could be turned into another dealer's hand (which may be better for the players).

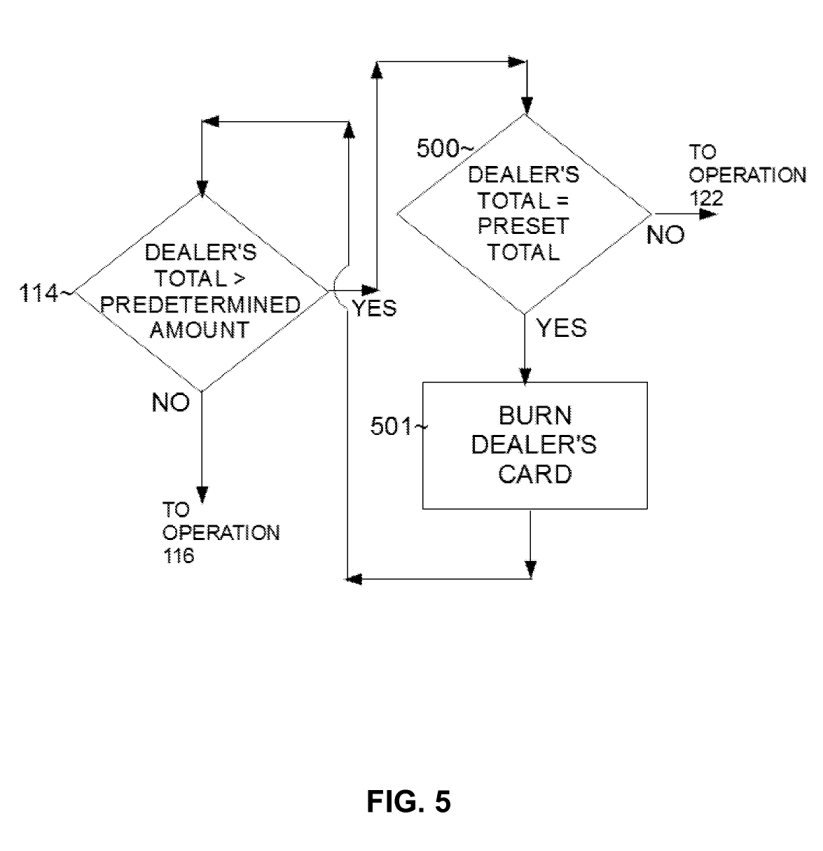

FIG. 5 is a flowchart illustrating an exemplary method of burning a dealer's card when the dealer's final total is a preset total, according to an embodiment.

In FIG. 5, FIG. 1 is constructively inserted into FIG. 5. Operation 114, in FIG. 5, is the same operation 114 as in FIG. 1. Instead of operation 114 proceeding to operation 122 in case of a “YES,” operation 114 now proceeds to operation 500 in case of a “YES.”

In operation 500, it is determined whether the dealer's total (the dealer's final point total) equals a preset total. The preset total is a single point total (typically from eighteen to twenty-one) that is predetermined before the start of the game (and forms part of the public game rules). In a further embodiment, operation 500 can compare whether the dealer's total equals one of a set of preset totals (e.g., seventeen to eighteen, seventeen and nineteen, etc.)

If, in operation 500, the dealer's total does not equal the preset total, then the method proceeds to operation 122, wherein the game proceeds normally.

If, in operation 500, the dealer's total equals the preset total, then the method proceeds to operation 501, in which a dealer's card, in the dealer's hand, is burned. The card burned can be the last card dealt to the dealer. In another embodiment, the card burned can be the dealer's hole card. In another embodiment. the card burned can be the dealer's up card. The burned card is removed from the dealer's hand and does not count in the dealer's point total. Then the method returns to operation 114. In another embodiment, from operation 501 the method proceeds to operation 116.

In the embodiment illustrated in FIG. 5, the decision to burn a dealer's card does not depend on how many cards are in the dealer's hand. This embodiment may be very strong for the player because, if the dealer is initially dealt (the two initial dealer's cards) the preset total, one of the cards would be burned. For example, if the preset total is twenty-one, and the dealer is initially dealt a blackjack, then this would qualify as being the preset total and a dealer's card would be burned. Then the method would continue to deal a replacement card to the dealer in operation 116.

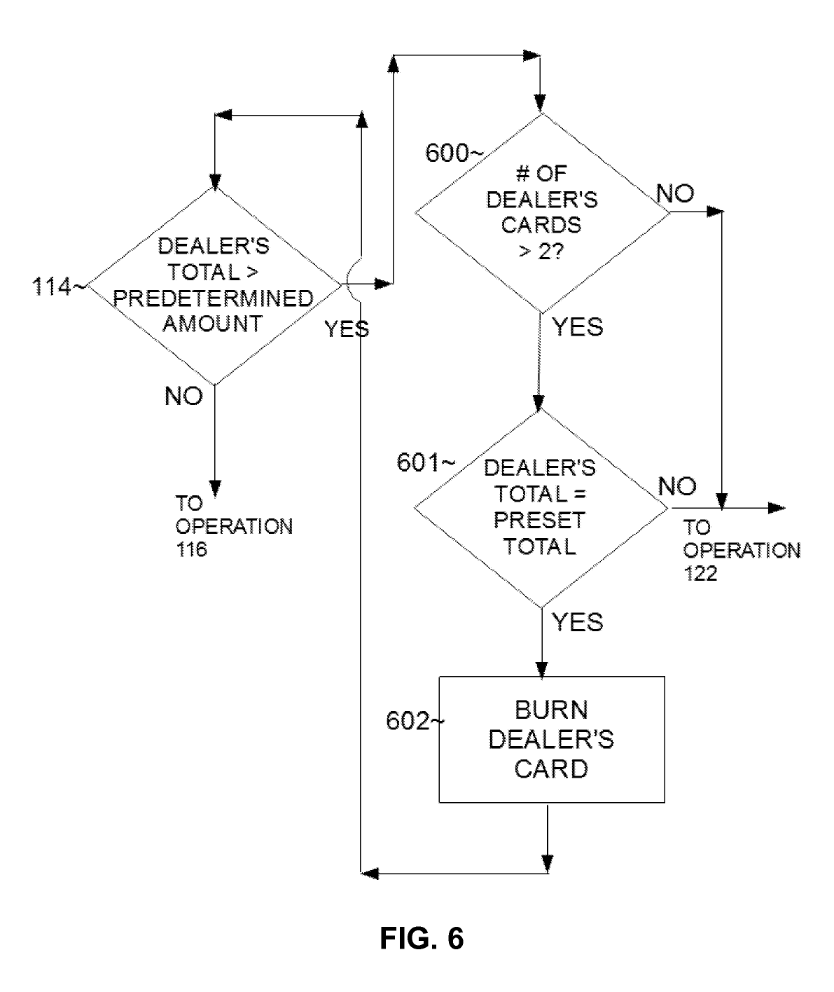

FIG. 6 is a flowchart illustrating an exemplary method of burning a dealer's card when the dealer's final total is a preset total and the dealer's hand is formed using more than two cards, according to an embodiment.

In FIG. 6, FIG. 1 is constructively inserted into FIG. 6. Operation 114, in FIG. 6, is the same operation 114 as in FIG. 1. Instead of operation 114 proceeding to operation 122 in case of a “YES,” operation 114 now proceeds to operation 600 in case of a “YES.”

In operation 600, it is determined whether the number of cards in the dealer's hand is greater than two. If the number of cards in the dealer's hand is not greater than two (the dealer is standing on the dealer's initially dealt hand such as if the dealer was initially dealt a point total of seventeen to twenty-one), then the method proceeds to operation 122 and the game continues normally. This is because, in this embodiment, one of the dealer's cards is burned only if the dealer draws to the preset total. (If the dealer was initially dealt the preset total, then a dealer's card would not be burned, and the game would proceed normally to operation 122.)

If the number of dealer's cards is greater than two, then the method proceeds to operation 601. For example, if the dealer was initially dealt a ten and a five and the dealer drew a six, this would be three dealer's cards (greater than two). In operation 601, it is determined whether the dealer's total equals the preset total. The preset total is a single point total (typically from eighteen to twenty-one) that is predetermined before the start of the game (and forms part of the public game rules). In a further embodiment, operation 500 can determine whether the dealer's total equals one of a set of preset totals (e.g., seventeen to eighteen, seventeen and nineteen, etc.). If, in operation 601, the dealer's total is not equal to the preset total, then the method proceeds to operation 122, wherein no dealer's card is burned and the game continues normally.

If, in operation 601, it is determined that the dealer's total equals the preset total, the method proceeds to operation 602, wherein a dealer's card is burned. The card burned can be the last card dealt to the dealer. In another embodiment, the card burned can be the dealer's hole card. In another embodiment. the card burned can be the dealer's up card. The burned card is removed from the dealer's hand and does not count in the dealer's point total. Then the method returns to operation 114. In another embodiment, from operation 602 the method proceeds to operation 116.

In the embodiments illustrated in FIGS. 5 and 6, the dealer would continuously burn cards as needed, in accordance with the flowchart. In a further embodiment, the dealer would burn a card only one time. Thus, if the dealer burned a card (in operations 501 or 602), the dealer would not burn another card in the same game. Thus, in FIG. 5, operation 500 would (A) determine whether the dealer's total equals the preset total and (B) determine whether operation 501 had not already been performed in this game. Thus, in operation 500, if operation 501 had already been performed (a dealer's card had already been burned during the same game), then operation 500 would always proceed to operation 122 (no further dealer's cards would be burned). In FIG. 6, operation 600 would (A) determine whether the number of dealer's cards is greater than two and (B) determine whether operation 602 had not already been performed in the same game. Thus, in operation 600, if operation 602 had already been performed (a dealer's card had already been burned during the same game), then operation 600 would always proceed to operation 122 (no further dealer's cards would be burned).

Some examples of the embodiment illustrated in FIG. 6 will now be presented (with the preset total being twenty-one). In a first example, Bart places a $1 wager. The dealer deals Bart a ten-spades (10 [symbol] ) and a five-hearts (5♡) (player's hand), and the dealer is dealt a dealer's hand of an eight-hearts (8♡) and a hole card (face down). Bart decides to hit and receives a four-spades (4 [symbol] ) for a total of nineteen. Then Bart stands. The dealer then reveals the dealer's hole card to be a five (5) for a point total of thirteen. Because thirteen is less than seventeen, the dealer hits and deals an eight-spades (8 [symbol] ) for a point total of twenty-one. Because the dealer's point total of twenty-one equals the preset total (twenty-one), the dealer burns the last card dealt (the eight-spades (8 [symbol] )) by discarding the eight-spades (8 [symbol] ), which no longer counts as part of the dealer's point total, and the dealer deals himself a third card of a five-spades (5 [symbol] ) for a point total of eighteen. Because the dealer's point total of eighteen is higher than seventeen (operation 114), the dealer does not need to deal himself any additional cards; thus, the dealer stands. Because Bart's point total of nineteen is higher than the dealer's point total of eighteen, Bart wins the blackjack game and wins a $1 payout (so Bart now has, on the table, $2 in chips he can keep). Note that. if the dealer's point total of twenty-one was achieved on a number of dealer cards greater than three, the procedure would still be the same (the dealer would burn the last card dealt and continue resolving the dealer's hand).

In a further example, Homer places a $1 wager. The dealer deals Homer a ten-spades/ten-hearts (10 [symbol] /10♡). The dealer deals himself a ten-hearts (10♡) (up card) and a hole card face down. Homer stands. The dealer then reveals the hole card to be an ace (A), for a point total of twenty-one. In the embodiment illustrated in FIG. 6 (which requires more than two dealer cards to initiate a burn), the dealer would not burn a card (even though the dealer's point total equals the preset total of twenty-one) because the dealer's hand is not made of more than two cards. Thus, the dealer wins, and Homer loses the $1 wager. In the embodiment illustrated in FIG. 5 (in which a dealer would burn a card regardless of how many cards are in the dealer's hand), two outcomes could possibly result depending on the embodiment. In one embodiment, a dealer blackjack (an initially dealt hand of ace and ten) always wins (unless the player is also dealt a blackjack, in which event the result is a push); thus, Homer would lose the $1 wager. In a second embodiment of FIG. 5, the dealer would burn the last card (either the hole card or the up card) and deal a new card to the dealer, and the dealer continues to play out the dealer's hand, resuming at operation 114.

In yet another example, Marge places a $1 bet. The dealer deals Marge a two-spades/nine-hearts (2 [symbol] /9♡). The dealer deals himself a nine-clubs (9 [symbol] and a hole card. Marge doubles, places another $1 bet, and is dealt an eight-spades (8 [symbol] ) for a point total of nineteen. The dealer now reveals the hole card to be a two-clubs (2 [symbol] ). Because the dealer's point total of eleven is less than seventeen, the dealer hits and draws a ten-spades (10 [symbol] ) for a point total of twenty-one. Because twenty-one is the preset total, the dealer burns the last card (ten-spades (10 [symbol] )) and now deals another (third) card of a three-diamonds (3♦) for a total of fourteen. The dealer now hits again (because fourteen is less than seventeen) and deals himself a seven-diamonds (7♡) for a point total of twenty-one. In a first embodiment, the dealer would not burn a second time in the same game; thus, the dealer's hand of twenty-one is final and beats Marge's point total of nineteen. (Thus, Marge loses the $2 in wagers.) In a second embodiment, the dealer would burn a second time in the same game; thus, the dealer would burn the last card of the seven-diamonds (7♦) and now deals a ten-diamonds (10♦), which gives the dealer a point total of twenty-four, which is a bust. Thus, Marge wins (operation 120) $2 (she now has, on the table, $4 in chips she can keep), and the game ends. Note that, in one variation of this second embodiment, the dealer can burn as many times as needed in the same game. In another variation of this second embodiment, the dealer has an upper limit of how many burns the dealer is permitted to perform in the same game (e.g., three burns) before the dealer will no longer burn and will rest with the final total equal to the preset total.

It is noted that the methods described herein can be played with any number of standard decks of fifty-two cards (e.g., one deck to ten decks). A standard deck is a collection of cards comprising an ace, a two, a three, a four, a five, a six, a seven, an eight, a nine, a ten, a jack, a queen, and a king for each of four suits (comprising spades, diamonds, clubs, hearts), totaling fifty-two cards. Cards can be shuffled, or a continuous shuffling machine (CSM) can be used. A standard deck of fifty-two cards can be used, as well as other kinds of decks, such as Spanish decks, decks with wild cards, etc. The operations described herein can be performed in any sensible order. Furthermore, numerous different variants of house rules can be applied.

Methods described herein can also be played on a physical table using physical cards and physical chips used to place wagers. Such physical chips can be directly redeemable for cash. When a player wins (dealer loses) the player's wager, the dealer will pay that player a respective payout amount. When a player loses (dealer wins) the player's wager, the dealer will take (collect) that wager from the player and typically place those chips in the dealer's chip rack. All rules, embodiments, features, etc., of a game being played are typically communicated to the player (e.g., verbally or on a written rule card) before the game begins.

Initial cash deposits can be made into the electronic gaming machine, which converts cash into electronic credits. Wagers can be placed in the form of electronic credits, which can be cashed out for real coins or a ticket (e.g., ticket-in-ticket-out), which can be redeemed at a casino cashier or kiosk for real cash and/or coins.

Any description of a component or embodiment herein also includes hardware, software, and configurations that already exist in the prior art and may be necessary to the operation of such component(s) or embodiment(s).

Further, the operations described herein can be performed in any sensible order. Any operations not required for proper operation can be optional. Further, all methods described herein can also be stored on a computer-readable storage to control a computer. All variations and features described herein can be combined with any other features described herein without limitation.

The many features and advantages of the invention are apparent from the detailed specification. Thus, it is intended by the appended claims to cover all such features and advantages of the invention that fall within the true spirit and scope of the invention. Further, because numerous modifications and changes will readily occur to those skilled in the art, it is not desired to limit the invention to the exact construction and operation illustrated and described. Accordingly, all suitable modifications and equivalents may be resorted to, falling within the scope of the invention.

What is claimed is:

1. A method of administering a blackjack game, the method comprising:
providing a physical gaming table with a felt layout on top of the physical gaming table, the felt layout including at least one betting circle associated with each of a plurality of player positions designated on the felt layout;
providing one or more physical decks of physical playing cards;
receiving a wager from a player in the form of one or more physical chips in a betting circle associated with at least one player position of the plurality of player positions;
dealing an initial hand of two physical playing cards using one or more physical decks of physical playing cards to each of the at least one player position and to a dealer;
determining a point total of each of the initial hands of physical playing cards of the dealer and the at least one player position;
replacing at least one physical playing card of at least one of the initial hands of two physical playing cards with at least one replacement physical playing card when the point total of the at least one of the initial hands of two physical playing cards is a value of a predetermined set of values;
playing out the at least one hand including the at least one replacement physical playing card; and
resolving the wager according to predetermined blackjack rules.

2. The method of claim 1, wherein replacing at least one physical playing card of at least one of the initial hands of two physical playing cards with at least one replacement physical playing card comprises automatically replacing the at least one physical playing card when the point total of the at least one of the initial hands of two physical playing cards is a value of a predetermined set of values.

3. The method of claim 1, wherein resolving the wager according to predetermined blackjack rules comprises returning the wager to the player when a final dealer hand has a point total of 22.

4. The method of claim 1, wherein resolving the wager according to predetermined blackjack rules comprises paying the player even money when a final hand of the at least one player position comprises a blackjack.

5. The method of claim 1, wherein replacing at least one physical playing card of at least one of the initial hands of two physical playing cards with at least one replacement physical playing card comprises replacing two physical playing cards with two replacement physical playing cards.

6. The method of claim 1, further comprising accepting a double down wager from the player in the form of one or more physical chips in the betting circle associated with the at least one player position after replacing the at least one physical playing card of the at least one of the initial hands of two physical playing cards with the at least one replacement physical playing card.

7. The method of claim 1, wherein replacing at least one physical playing card of at least one of the initial hands of two physical playing cards with at least one replacement physical playing card when the point total of the at least one of the initial hands of two physical playing cards is a value of a predetermined set of values comprises replacing the at least one physical playing card when the point total is 17 or 18.

8. The method of claim 1, further comprising accepting a split wager from the player in the form of one or more physical chips in the betting circle associated with the at least one player position.

9. A method for implementing a blackjack game in a physical casino, the method comprising:
providing, in the physical casino, a physical gaming table having a felt layout on top of the gaming table, the felt layout including at least one betting circle thereon associated with at least one player position;
receiving a main wager from a player in the form of one or more physical playing chips in the at least one betting circle;
dealing physical playing cards to the player and a dealer, the dealing physical playing cards comprising:
dealing an initial hand of two physical playing cards to the player; and
dealing an initial hand of two physical playing cards to the dealer;
replacing at least one physical playing card of at least one of the initial hands of two physical playing cards responsive to determining a point total of the at least one initial hand of two physical playing cards is a value of a set of preset totals to form at least one replacement hand;
playing out the at least one replacement hand according to predetermined blackjack rules; and
resolving the main wager.

10. The method of claim 9, wherein playing out the at least one replacement hand according to predetermined blackjack rules comprises paying the player even money on the main wager when a final player hand has a higher point total than a final dealer hand.

11. The method of claim 9, wherein replacing at least one physical playing card of at least one of the initial hands of two physical playing cards comprises replacing two physical playing cards to form the at least one replacement hand comprising two physical playing cards.

12. The method of claim 11, wherein replacing at least one physical playing card of at least one of the initial hands of two physical playing cards responsive to determining a point total of the at least one initial hand of two physical playing cards is a value of a set of preset totals comprises replacing the at least one physical playing card when the point total is 17 or 18.

13. The method of claim 9, wherein replacing at least one physical playing card of at least one of the initial hands of two physical playing cards responsive to determining a point total of the at least one initial hand of two physical playing cards is a value of a set of preset totals comprises dealing a replacement card face up to form the at least one replacement hand.

14. The method of claim 9, further comprising accepting at least one of a double down wager and a split wager from the player in the form of one or more physical chips in the betting circle associated with the at least one player position.

15. An electronic apparatus for administering a blackjack game, the apparatus comprising:
a processing unit in communication with an input device and an output device, the processing unit configured to execute instructions to:
receive an indication of a wager in response to a player input from a player through the input device;
deal an initial hand of two cards to form each of a player hand and a dealer hand, the cards being virtual cards or electronic representations of cards displayed on the output device;
determine a point total of at least one of the player hand and the dealer hand;
replace at least one card of at least one of the player hand and the dealer hand with at least one replacement card when a point total of the at least one hand is a value of a predetermined set of values;
play out the at least one hand including the at least one replacement card according to predetermined blackjack rules;
resolve the wager; and
display a result on the output device.

16. The electronic apparatus of claim 15, wherein the processing unit is further configured to receive an indication of at least one of a double down wager and a split wager in response to a player input from the player through the input device.

17. The electronic apparatus of claim 15, wherein the processing unit is further configured such that the value of the predetermined set of values is 17 or 18.

18. The electronic apparatus of claim 15, wherein the processing unit is further configured to automatically replace the at least one card responsive to determining that the point total of the at least one hand is a value of the predetermined set of values.

19. The electronic apparatus of claim 15, wherein the electronic apparatus is further configured to, when resolving the wager, return the wager to the player when a final dealer hand has a point total of 22.

20. The electronic apparatus of claim 15, wherein the electronic apparatus is further configured to, when resolving the wager, pay the player even money when a final player hand is a blackjack.
